(19) United States
(12) Patent Application Publication
(10) Pub. No.: US 2019/0327981 A1
(43) Pub. Date: Oct. 31, 2019

(54) METHOD FOR PREPARING CRACKERS FROM ERAGROSTIS TEF FLOUR

(71) Applicant: Ashish Mahendra MEHTA, Mumbai (IN)

(72) Inventor: Ashish Mahendra MEHTA, Mumbai (IN)

(21) Appl. No.: 16/016,574

(22) Filed: Jun. 23, 2018

(30) Foreign Application Priority Data
Apr. 28, 2018 (IN) 201821016139

(51) Int. Cl. A21D 13/04; A21D 13/44; A21D 13/24

(52) U.S. Cl. CPC A21D 13/04; A21D 13/24; A21D 13/44

(57) ABSTRACT

The present disclosure relates to a method for preparing crackers from Eragrostis tef flour. The method comprises mixing Eragrostis tef flour with a liquid medium and allowing the obtained batter to stand to obtain a fermented batter. The fermented batter is then uniformly spread to a wall thickness in the range of 3 mm to 5 mm on a heated griddle to obtain a crepe with random air pockets. The crepe is placed between a pair of heated discs and an incremental axially directed pressure is applied to reduce the wall thickness in the range of 0.5 mm to 1.5 mm to obtain the cracker. The crackers prepared by the method of the present disclosure retain the nutritional properties, are palatable, easily chewable and can be used as a healthy addition to the routinely used diet.

### FIELD OF INVENTION

The present disclosure relates to a method for preparing crackers from Eragrostis tef flour.

### DEFINITIONS

As used in the present disclosure, the following terms are generally intended to have the meaning as set forth below, except to the extent that the context in which they are used indicate otherwise.

Groover: The term “groover” refers to a device that makes grooves.

Griddle: The term “griddle” refers to a cooking device consisting of a broad flat surface made of clay that can be heated by gas, electricity, wood, or coal. It is also known as ‘Mad’ in Ethiopia.

Birds eye texture: The term “birds eye texture” refers to the pockets of air bubbles on the crackers.

### BACKGROUND OF THE INVENTION

Eragrostis tef, also known as “Teff” is a species of grass native to Ethiopia and Eritrea that is cultivated for its edible seeds. Teff is the staple food for a majority of the population in Ethiopia. Teff is high in protein, carbohydrates, dietary fiber, iron, and calcium. It has a high nutritive value and is used to prepare several dishes, including a popular fermented and flattened sour bread, namely, Injera.

Teff is gluten-free, and high in proteins, vitamins, and minerals, making it a popular life-style food. Further, Teff contains a high amount of ‘slowly-digestible’ starch, imparting it with a low glycemic index, and hence it is a suitable food for individuals suffering from diabetes.

Due to the various health benefits of Teff, there is an increasing demand for Teff based food products. However, most of the Teff based food products contain high amount of water and therefore have a short shelf life.

Also, it is well known that Teff cannot be eaten without fermentation because of its high Phytase content. Hence, most of the nutrients cannot be absorbed if Teff is eaten without ‘phytase degradation’ and will lead to indigestion. Teff is fermented to remove the phytase to make it suitable for digestion. Attempts have been made to prepare tortillas/rotis directly from Teff flour (non-fermented) and then roasted into crackers, but this leads to indigestion.

Traditionally to extend shelf life, the Infer& fermented Teff pancake is sun dried or oven dried. The dried product is known as ‘Dirkosh’ in Ethiopia. Dirkosh has a long shelf life and is typically rehydrated by soaking in water and is eaten as Injera/pancake (rehydrated). However, this dried form of Teff pancake/Injera is not palatable, is difficult to chew/masticate and hence, is rarely eaten in this dried form.

There is, therefore, felt a need for Teff based food products that are easily digestible, contains all the nutrients, readily available, is palatable, and can be stored for a long time.

### OBJECTS OF THE INVENTION

Some of the objects of the present disclosure, which at least one embodiment herein satisfies, are as follows:

It is an object of the present disclosure to ameliorate one or more problems of the prior art or to at least provide a useful alternative.

Another object of the present disclosure is to provide a method for preparing crackers from Eragrostis tef flour.

Still another object of the present disclosure is to provide a method of preparing crackers from Eragrostis tef flour that retains the nutritional properties of the Eragrostis tef flour.

Yet another object of the present disclosure is to provide crackers prepared from Eragrostis tef flour that are easily chewable and digestible, and has a long shelf life.

Other objects and advantages of the present disclosure will be more apparent from the following description, which is not intended to limit the scope of the present disclosure.

### SUMMARY OF THE INVENTION

The present disclosure provides a method for preparing crackers from Eragrostis tef flour. The method comprises mixing the Eragrostis tef flour with a liquid medium and a starter mixture to obtain a batter. The batter is fermented to obtain a fermented batter, which is then used to prepare a crepe/pancake with random air pockets, and a water content in the range of 50% to 70% of the mass of the crepe. The crepe is then placed between a pair of heated discs and an incremental axially directed pressure is applied to reduce its wall thickness in the range of 0.5 mm to 1.5 mm and obtain the crackers. Typically, the moisture content of the crackers is in the range of 1% to 5% of the mass of the crackers.

### DETAILED DESCRIPTION OF THE INVENTION

Teff (Eragrostis tet) is a small, gluten-free grain having numerous health benefits. Teff is a high-fibre food, and a good source of protein, manganese, iron, calcium vitamins and minerals. Further, Teff contains low amounts of sodium, and saturated fat. There is huge demand for Teff based food products due to its various health and nutritional benefits.

Though the preparation of fermented crepe (Injera) from Teff is widely known in Ethiopia, its sundried form (Dirkosh) is not palatable and difficult to chew. The present disclosure therefore envisages a method for preparing crackers from

Eragrostis tef flour, wherein the traditionally prepared Injera is pressure-flattened/roasted during dehydration, thus increasing its palatability, shelf life and also retains the nutritional properties.

In an aspect of the present disclosure, there is provided a method for preparing crackers from Eragrostis tef flour. The method is hereinafter described in detail.

Initially, Eragrostis tef flour is mixed with a liquid medium and a starter mixture to obtain a batter.

Eragrostis tef (Poaceae) also known as Teff, Williams' lovegrass or annual bunch grass, is an annual grass, a species of lovegrass that is native to Ethiopia and Eritrea.

Typically, the Eragrostis tef seeds are ground into a fine flour in a mill. In an embodiment, the liquid medium is water. The ratio of Eragrostis tef flour to water can be in the range of 1:1.5 to 1:2.

The batter is fermented for a time period in the range of 1 day to 5 days to obtain a fermented batter. Typically, salt and optionally a flavoring agent are added in the fermented batter before poring it on a griddle. In an embodiment, the salt is non-iodized, preferably sea salt is used. In one embodiment, black salt is added to the batter before the start of the fermentation. The flavoring agent can be selected from the group consisting of mint (Mentha spicata), cumin (Cuminum cyminum), cinnamon (Cinnamomum verum), cardamom (Elettaria cardamomum), bishop's weed (Trachyspermum ammi), fenugreek (Trigonella foenum-graecum), coriander (Coriandrum sativum), sesame (Sesamum indicum), and dill (Anethum graveolens). Typically, the fermentation is carried out at a temperature in the range of 10° C. to 35° C. The Eragrostis tef flour may be optionally mixed with at least one of grain flour and pulse flour before the preparation of the batter.

Typically, the starter mixture comprises at least one microorganisms, selected from the group consisting of Enterobacteriaceae sp., Leuconostoc mesenteroides, Enterococcus faecalis (Streptococcus faecalis), Pediococcus cerevisiae, Lactobacillus brevis, Lactobacillus plantarum, and Lactobacillus fermentum. These microorganisms aid the fermentation process.

The fermented batter is uniformly spread to a wall thickness in the range of 3 mm to 5 mm on a heated griddle to obtain a crepe. The crepe contains random air pockets on top side (bird eye texture), and has a water content in the range of 50% to 70% of the mass of the crepe. Typically, the heated griddle has a temperature in the range of 250° C. to 290° C. In one embodiment the crepe is also flipped/turned over and baked on the both sides, on the same griddle to partially reduce the water content.

The crepe is placed between a pair of heated discs and an incremental axially directed pressure is applied to reduce its wall thickness in the range of 0.5 mm to 1.5 mm to obtain the crackers having a moisture content of less than 5% of the mass of the crackers. Typically, the heated discs are electrically heated using a timer controlled relay and can have a temperature in the range of 170° C. to 240° C. Typically, the pressure is applied to the crepes in a step-wise manner so as to preserve the ‘bird eye texture’ and to avoid deforming the shape of the final cracker due to smudging. In an embodiment, a first pressure in the range of 0.1 kg/cm² to 2 kg/cm² is applied for a time period of 10 seconds to 20 seconds. The action of the heated discs and the pressure result in the removal of water, which is released in the form of steam from the crepe. A sizzling sound is noticed during this process. After 20 seconds, the pressure is increased, which results in a further removal of water from the crepe. The pressure is gradually increased in a step-wise manner in the range of 30 kg/cm² 50 kg/cm². The total time taken to roast the cracker is approximately 80 seconds to 100 seconds until they are light brown in color. Care is taken that the cracker is not burned during the roasting/dehydrating step. The simultaneous action of heat and pressure considerably lowers the wall thickness of the crepe, along with the removal of water to obtain crackers having a wall thickness in the range of 0.5 mm to 1.5 mm and a moisture content of less than 5% of the mass of the crackers.

Typically, a release agent is applied to the crepe and the pair of discs, before the pressure is applied. In one embodiment, the release agent is an edible oil. The edible oil can be selected from the group consisting of sunflower oil (Helianthus annuus), olive oil (Olea europaea), ground nut oil (Arachis hypogaea), and sesame oil (Sesamum indicum). The use of oil during the roasting/dehydrating step also enhances the taste of the crackers.

The discs are made of a non-stick and rigid material. In an embodiment, the discs are perforated. In another embodiment, the discs are not perforated. The discs contain groover of pre-determined shape and size.

Typically, seasoning is applied/added to the crackers before cooling to ensure that the seasoning adheres to the cracker. The ‘Bird Eye Texture’ on one side aids in the easy application of the seasoning. The crackers are then cooled and cut along the grooves before packing. In an embodiment, the seasoning is added to the batter before the fermentation step. The seasoning can be selected from the group consisting of cheese, tomato, chilli, barbeque, sour cream, onion, and garlic. Typically, the packing is carried out under nitrogen and flexible barrier film packaging in the form of ‘stand up pouch’.

The present disclosure further provide crackers prepared from Eragrostis tef flour, having a thickness in the range of 0.5 mm to 1.5 mm and a water content of less than 5% of the mass of the crackers, and characterized by a shelf life of 6 months.

Typically, the fermentation lowers the pH of the batter in the range of 3 to 4, and hence delivers a sour taste to the crackers.

The crackers prepared by the method of the present disclosure are healthy, and are capable of boosting immunity, bone strengthening, stimulating digestion, managing diabetes, and increasing haemoglobin levels. Further, the crackers have a pleasant taste, and are easily palatable.

The use of the fermented batter for preparing the crackers in accordance with the process of the present disclosure aids in the absorption of the nutrients as the phytic acid is removed during the fermentation. Further, the incremental pressure applied during the dehydrating/roasting step preserves the ‘bird eye’ texture of the Injera/pancake, which is highly appealing to the consumer and is the signature identity of fermentation and of the highly popular Injera pancake eaten in Ethiopia. This Texture also greatly helps in the application of seasonings post roasting. The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

Experimental Detail

Experiment-1:

The Teff used in the crackers was sourced from Ethiopia. Experiments were carried out in Addis Ababa, Ethiopia.

The crackers from Eragrostis tef flour in accordance with the present disclosure were prepared by the following general procedure.

Finely milled Eragrostis tef flour (2 kg) was mixed with water (6,500 ml) and starter (containing natural Lactobacillus brevis) to obtain a batter which was allowed to stand for 72 hours to obtain a fermented batter (first stage of fermentation). During fermentation, gas (carbon dioxide) was released, which resulted in the rising of the batter. The pH of the batter after 72 hours was found to be 3.5. The phytic acid formed on the surface in the form of acidic yellowish liquid was discarded by draining. Thereafter, the batter was subjected to a second stage of fermentation wherein 10% of the fermented batter was boiled for 5 minutes and then mixed with the rest of the fermented batter and allowed to stand for 60 minutes, to enhance the gas (CO₂) formation and dough rising.

The fermented batter was uniformly spread (wall thickness of 4.6 mm) on a heated circular griddle (290° C.) with cover and cooked for 2 minutes to obtain a crepe with random air pockets (air bubbles or bird eyes). The crepe (diameter 53 cm and weight 350g, wall thickness of 3 mm to 4 mm) was then placed between a pair of heated discs (190° C.). 10 g of refined sunflower oil was applied on the crepe and an axially directed pressure of 0.1 kg/cm² was applied to the crepe for 20 seconds. After 20 seconds the pressure was increased to 5 kg/cm². Similarly, in a step-wise manner, the pressure was increased up to 30 kg/cm² to obtain a cracker (weight 117 g, wall thickness of 0.5 mm). Care was taken to make the crackers' light brown, without burning it. . The total time taken to roast the crackers was 80 seconds. The ambient room temperature was 25° C. Similarly, different batches of crackers (Examples 1 to 5) were prepared from crepes, in accordance with the method of the present disclosure.

The weight for the different batches (Examples 1 to 5) of the crepes and the crackers, along with moisture content (%) in the crackers is summarized in Table-1.

TABLE 1
Comparison of the water content in the crepe and the crackers
prepared in accordance with the present disclosure

| | | | | Weight | | Moisture |
|---|---|---|---|---|---|---|
| Ex- | Weight | Thickness | Amount | of | Thickness | content |
| ample | of crepe | of crepe | of oil* | cracker | of cracker | (%) in |
| No. | (g) | (mm) | (g) | (g) | (mm) | cracker |
| 1 | 290 | 4.1 | 10 | 142.1 | 0.5 | 1 |
| 2 | 310 | 4.4 | 12^{#} | 145.2 | 0.6 | 1 |
| 3 | 301 | 3.8 | 12^{@} | 141.4 | 0.7 | 2 |
| 4 | 280 | 4.2 | 10^{@} | 149.3 | 0.9 | 3 |
| 5 | 320 | 4.5 | 11^{@} | 143.4 | 0.6 | 2 |

*oil is the release agent:
^{@}= olive oil,
^{#}= sunflower oil,
$ = sesame oil

It is seen from Table-1 that the water content in the crackers is significantly lower than the water content of the crepes. This indicates that the moisture content of the crackers prepared by the method of the present disclosure is very low and hence has a longer shelf life.

Experiment-2: Organoleptic Studies

The crackers prepared in accordance with the present disclosure were given to a group of 10 volunteers. All the 10 volunteers reported that the crackers were crispy and easily chewable (mastication) without any hint of sogginess or hardness. They also reported that the crackers prepared in accordance with the present disclosure were less sour as compared to the traditional Injera. Further, the crackers were palatable and did not have any unpleasant odor or taste.

Experiment-3: Shelf-Life Studies of the Crackers Prepared in Accordance with the Present Disclosure

Shelf-life studies were carried out for the crackers prepared in accordance with the present disclosure. The crackers prepared in Experiment-1 (Example 1 to 5; having a moisture content of less than 5%) and the crepe having a water content in the range of 50% to 70% were used in the shelf-life studies. All the samples were stored at 35° C. and 90% Relative Humidity. After 3 days, the crepe had lost its organoleptic properties and was unfit for human consumption. Bacterial and mold growth were observed on the crepe, and hence was inedible. However, there were no changes in the characteristics of the crackers prepared by the method of the present disclosure. The crackers were stable up to 180 days at 35° C. and 90% Relative Humidity.

Experiment-4: Efficacy Study of the Crackers Prepared in Accordance with the Present Disclosure:

Studies were carried out to determine the effect of the crackers prepared in accordance with the method of the present disclosure, on the health by testing the product on volunteers. The medical history of the volunteers was assessed before the start of the study. Volunteers of both genders of age between 19 to 57 years, having symptoms such as diabetes, anaemia, celiac disease, weight related problems, osteoporosis, calcium deficiency, people having lower level of insulin resistance, sinusitis, joint pain, and the like, and those willing to participate in the study were chosen. Some of the volunteers had multiple symptoms, such as i) sinusitis, fever, and chills, and diabetes; ii) joint pain, and celiac disease; and iii) anaemia, and joint pain. Volunteers having any major systemic diseases, including genetic/endocrinal diseases, cancer, HIV/AIDS, etc., having an addiction of alcohol or smoking or tobacco chewing, pregnant or lactating women, and having known hypersensitivity to the ingredients used in the crackers were excluded from the study. A total of 65 volunteers were enrolled for the study comprising, 35 males and 30 females. The study was conducted for a period of 120 days. The volunteers were asked to consume the crackers prepared by the method of the present disclosure during their main meals instead of the routine diet.

After the completion of the study, 15 volunteers presented with anaemia reported an increase in the haemoglobin levels.

17 volunteers presented with calcium deficiency and osteoporosis reported an increase in the calcium/magnesium/phosphorous/manganese (bone minerals) levels within an average of 30 days after consuming the crackers of the present disclosure. Further, these volunteers also reported a reduction in the osteoporosis related symptoms, such as frequent bone fractures. The gluten-free nature of the Teff flour is suggested to aid in the reduction in these symptoms.

7 volunteers presented with insulin resistance were started on a diet comprising the crackers prepared by the method of the present disclosure. The volunteers reported lower blood glucose levels and better insulin level (both fasting and postprandial), as variation in glucose levels subsided within 7 days of starting the diet comprising the crackers prepared by the method of the present disclosure.

4 volunteers presented with chronic weight problem, obesity and food addiction reported that they had a feeling of fullness and did not feel hungry for at least 4-5 hours post consumption of crackers which was the reason for a significant reduction in body weight within an average of 60 days after starting on a diet comprising the crackers of the present disclosure.

11 volunteers presented with lack of appetite and low energy levels were started on a diet comprising the crackers of the present disclosure. The volunteers reported a substantial increase in appetite on an average 15 days after consuming the crackers of the present disclosure.

Further, all the volunteers reported a significant increase in the energy level, and relief from bloating sensation. None of the volunteers reported any untoward incidence after consuming the crackers of the present disclosure.

Of the 65 volunteers enrolled in the study, 6 did not complete the study, and 10 volunteers were placed in a 6 month study, for which the trial is ongoing and the result is awaited.

It is evident from the study that the crackers of the present disclosure are capable of treating anaemia by increasing the haemoglobin level in the blood. Further, the crackers are capable of weight management, and bone strengthening. Teff can be used for the management of diabetes because of its low glycemic index. The crackers also stimulate digestion, the Zinc and Copper present in the Teff flour boosts the immune system, provides protein, and are gluten free alternative. Hence, the crackers of the present disclosure are capable of enhancing the overall health and immunity of the individuals who consume it. Moreover, the crackers due to the lower amount of water have a long shelf life and can be made to be easily available.

Technical Advancements

The present disclosure described herein above has several technical advantages including, but not limited to, the realization of a method for preparing crackers from Eragrostis tef flour. The crackers prepared by the method of the present disclosure retain the nutritional properties and hence are beneficial to the health.

The embodiments as described herein above, and various features and advantageous details thereof are explained with reference to the non-limiting embodiments in the description. Descriptions of well-known aspects, components and molecular biology techniques are omitted so as to not unnecessarily obscure the embodiments herein.

The foregoing description of specific embodiments so fully reveal the general nature of the embodiments herein, that others can, by applying current knowledge, readily modify and/or adapt for various applications of such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Further, it is to be distinctly understood that the foregoing descriptive matter is to be interpreted merely as illustrative of the disclosure and not as a limitation.

Having described and illustrated the principles of the present disclosure with reference to the described embodiments, it will be recognized that the described embodiments can be modified in arrangement and detail without departing from the scope of such principles.

While considerable emphasis has been placed herein on the particular features of this disclosure, it will be appreciated that various modifications can be made, and that many changes can be made in the preferred embodiment without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A method for preparing crackers from Eragrostis tef flour, said method comprising the following steps:
a. mixing said Eragrostis tef flour with a liquid medium and a starter mixture to obtain a batter;
b. fermenting said batter for a time period in the range of 1 day to 5 days to obtain a fermented batter;
c. uniformly spreading out said fermented batter to a wall thickness in the range of 3 mm to 5 mm on a heated griddle to obtain a crepe with random air pockets, and a water content in the range of 50% to 70% of the mass of said crepe; and
d. placing said crepe between a pair of heated discs and applying incremental axially directed pressure to reduce the wall thickness in the range of 0.5 mm to 1.5 mm and obtain said crackers having a moisture content in the range of 1% to 5% of the mass of said crackers.

2. The method as claimed in claim 1, wherein said heated griddle has a temperature in the range of 250° C. to 290° C.

3. The method as claimed in claim 1, wherein said heated discs are electrically heated using a timer controlled relay and have a temperature in the range of 170° C. to 240° C.

4. The method as claimed in claim 1, wherein said pressure in step (d) is applied in a step-wise manner with an initial pressure in the range of 0.1 kg/cm² to 2 kg/cm², which is gradually increased up to 30 kg/cm² to 50 kg/cm².

5. The method as claimed in claim 1, wherein a release agent is applied to said crepe and said pair of discs, wherein said release agent is an edible oil selected from the group consisting of sunflower oil, olive oil, ground nut oil, and sesame oil.

6. The method as claimed in claim 1, wherein said discs contain groover of pre-determined shape and size.

7. The method as claimed in claim 1, wherein said disc is made of a non-stick and rigid material.

8. The method as claimed in claim 1, wherein said discs are perforated.

9. The method as claimed in claim 1, wherein said discs are not perforated.

10. The method as claimed in claim 1, wherein salt and optionally at least one flavoring agent are added to the batter before fermentation in step (b).

11. The method as claimed in claim 10, wherein said flavoring agent is selected from the group consisting of mint, cumin, cinnamon, cardamom, bishop's weed, fenugreek, coriander, sesame, and dill.

12. The method as claimed in claim 1, wherein said crackers are cooled and cut along the grooves before packing.

13. The method as claimed in claim 1, wherein seasoning is applied to the crackers before cooling, wherein said seasoning i selected from the group consisting of cheese, tomato, chilli, barbeque, sour cream, onion, and garlic.

14. The method as claimed in claim 1, wherein said starter mixture comprises at least one microorganism selected from the group consisting of Enterobacteriaceae sp., Leuconostoc mesenteroides, Enterococcus faecalis (Streptococcus faecalis), Pediococcus cerevisiae, Lactobacillus brevis, Lactobacillus plantarum, and Lactobacillus fermentum.

15. The method as claimed in claim 1, wherein Eragrostis tef flour is mixed with at least one of grain flour and pulse flour before the preparation of said batter.

16. The method as claimed in claim 1, wherein a birds eye texture is formed on said crackers as a result of the incremental axially directed pressure applied on said crepes.

17. Crackers prepared from Eragrostis tef flour as claimed in claim 1, having a thickness in the range of 0.5 mm to 1.5 mm and a water content of less than 5% of mass of said crackers, and characterized by a shelf life of up to 6 months.
